(19) United States
(12) Patent Application Publication
(10) Pub. No.: US 2025/0110092 A1
(43) Pub. Date: Apr. 3, 2025

(54) MICROFLUIDIC CHIP

(71) Applicant: International Business Machines Corporation, Armonk, NY (US)

(72) Inventors: Ademir Ferreira da Silva, São Paulo (BR); Matheus Esteves, Rio de Janeiro (BR); Jaione Tirapu Azpiroz, Rio de Janeiro (BR); Benjamin Hardy Wunsch, Mt. Kisco, NY (US); Ricardo Luis Ohta, Sao Paulo (BR); Mathias B. Steiner, Rio de Janeiro (BR); Mariana Rodrigues Del Grande, Rio de Janeiro (BR)

(21) Appl. No.: 18/479,241

(22) Filed: Oct. 2, 2023

(51) Int. Cl. G01N 31/02; B01L 3/00

(52) U.S. Cl. CPC G01N 31/02; B01L 3/502761; B01L 2200/0647; B01L 2200/10; B01L 2300/0654; B01L 2300/16; B01L 2400/086

(57) ABSTRACT

A lab-on-chip platform is provided and includes a substrate. The substrate includes a microfluidic path. The microfluidic path has multiple inputs and an output and an analysis area downstream from a mixing area. The lab-on-chip platform further includes a cover disposed on the substrate to partially enclose the microfluidic path, a mineral layer deposited in at least the mixing area and obstructions. The mineral layer is configured to at least partially chemically react with fluid within the microfluidic path to form at least first particles and second particles, which are substantially smaller than the first particles. The obstructions are formed or disposed in the analysis area and configured to capture the first particles in the analysis area and to allow the second particles and unreacted fluid to pass out of the analysis area.

### BACKGROUND

The present invention generally relates to fabrication methods and resulting structures for microfluidic chips. More specifically, the present invention relates to a microfluidic chip that may be utilized in, for example, carbon dioxide mineralization studies.

Carbon sequestration is part of the natural carbon cycle by which carbon is exchanged among the biosphere, pedosphere, geosphere, hydrosphere and atmosphere of Earth. Carbon in a format of carbon dioxide (CO₂) is naturally captured from the atmosphere through biological, chemical and physical processes and is stored in ocean, soil and rock reservoirs. Besides natural processes, CO₂ capture and storage can be also performed by artificial processes.

CO₂ storage technologies can store CO₂ in geological formations by the reaction of CO₂ with metal oxides to produce stable carbonates.

### SUMMARY

According to an aspect of the invention, a lab-on-chip platform is provided. A non-limiting example of the lab-on-chip platform includes a substrate. The substrate includes a microfluidic path. The microfluidic path has multiple inputs and an output and an analysis area downstream from a mixing area. The lab-on-chip platform further includes a cover disposed on the substrate to partially enclose the microfluidic path, a mineral layer deposited in at least the mixing area and obstructions. The mineral layer is configured to at least partially chemically react with fluid within the microfluidic path to form at least first particles and second particles, which are substantially smaller than the first particles. The obstructions are formed or disposed in the analysis area and configured to capture the first particles in the analysis area and to allow the second particles and unreacted fluid to pass out of the analysis area. Additionally or alternatively, the lab-on-chip platform provides for a microfluidic chip that can be used to quantify key mineralization aspects, for instance, carbonate volume generated, mineralization rate, rock dissolution rate, crystal formation time, etc.

According to an aspect of the invention, a method of mineralization rate measurement is provided. A non-limiting example of the method includes forming a lab-on-chip platform with a microfluidic path having multiple inputs and an output and an analysis area downstream from a mixing area, depositing a mineral layer in at least the mixing area, forming or disposing obstructions in the analysis area and disposing a cover on a substrate to partially enclose the microfluidic path. The method further includes flowing a fluid along the microfluidic path such that, in the mixing area, the fluid forms first particles and second particles, which are substantially smaller than the first particles, through chemical interactions with the mineral layer or remains unreacted, and, in the analysis area, the obstructions capture the first particles and allow the second particles and unreacted fluid to pass out of the analysis area. In addition, the method includes analyzing a presence of the first particles captured in the analysis area to determine a mineralization rate. Additionally or alternatively, the method provides for quantification of key mineralization aspects, for instance, carbonate volume generated, mineralization rate, rock dissolution rate, crystal formation time, etc.

According to an aspect of the invention, a lab-on-chip platform is provided. A non-limiting example of the lab-on-chip platform includes a substrate in which a microfluidic path is formed having multiple inputs and an output and an analysis area, a cover placed on the substrate to partially enclose the microfluidic path and a mineral layer disposed in the microfluidic path and including a central mineral layer sandwiched between non-mineral layers. The central mineral layer is exposed to and etched by fluid flowing along the microfluidic path such that a capacitance of the mineral layer changes over time. Additionally or alternatively, the lab-on-chip platform provides for a microfluidic chip that can be used to quantify key mineralization aspects, for instance, carbonate volume generated, mineralization rate, rock dissolution rate, crystal formation time, etc.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1A depicts a perspective view of an apparatus for mineralization rate measurement including a lab-on-chip platform with bottlenecks in an analysis area and a data acquisition system (DAS) in accordance with one or more embodiments of the present invention;

FIG. 1B depicts a cross section view of a microfluidic path of the lab-on-chip platform of FIG. 1A in accordance with one or more embodiments of the present invention;

FIG. 2 depicts an enlarged perspective view of the analysis area of the lab-on-chip platform of FIGS. 1A and 1B in accordance with one or more embodiments of the present invention;

FIG. 3A depicts a perspective view of an apparatus for mineralization rate measurement including a lab-on-chip platform with a sieve in an analysis area and a data acquisition system (DAS) in accordance with one or more embodiments of the present invention;

FIG. 3B depicts a cross section view of a microfluidic path of the lab-on-chip platform of FIG. 3A in accordance with one or more embodiments of the present invention;

FIG. 4 depicts an enlarged perspective view of the analysis area of the lab-on-chip platform of FIGS. 3A and 3B in accordance with one or more embodiments of the present invention;

FIG. 5 is a flow diagram illustrating a method of mineralization rate measurement in accordance with one or more embodiments of the present invention;

FIG. 6 depicts a cross section view of a mineral layer provided in a microfluidic path of a lab-on-chip platform in accordance with one or more embodiments of the present invention;

FIG. 7 depicts a perspective view of the mineral layer of FIG. 6 in accordance with one or more embodiments of the present invention;

FIG. 8A depicts a side view illustrating a central mineral layer of the mineral layer of FIGS. 6 and 7 in accordance with one or more embodiments of the present invention;

FIG. 8B depicts a side view illustrating an etching of the central mineral layer of FIG. 8A in accordance with one or more embodiments of the present invention; and

FIG. 9 depicts a perspective view of a mineral layer provided in a microfluidic path of a lab-on-chip platform with first and second sections in accordance with one or more embodiments of the present invention.

The diagrams depicted herein are illustrative. There can be many variations to the diagram, or the operations described therein without departing from the spirit of the invention. For instance, the actions can be performed in a differing order or actions can be added, deleted, or modified. Also, the term “coupled” and variations thereof describes having a communications path between two elements and does not imply a direct connection between the elements with no intervening elements/connections between them. All these variations are considered a part of the specification.

In the accompanying figures and following detailed description of the described embodiments, the various elements illustrated in the figures are provided with two-or three-digit reference numbers. With minor exceptions, the leftmost digit(s) of each reference number corresponds to the figure in which its element is first illustrated.

### DETAILED DESCRIPTION

According to an aspect of the invention, a lab-on-chip platform is provided. A non-limiting example of the lab-on-chip platform includes a substrate. The substrate includes a microfluidic path. The microfluidic path has multiple inputs and an output and an analysis area downstream from a mixing area. The lab-on-chip platform further includes a cover disposed on the substrate to partially enclose the microfluidic path, a mineral layer deposited in at least the mixing area and obstructions. The mineral layer is configured to at least partially chemically react with fluid within the microfluidic path to form at least first particles and second particles, which are substantially smaller than the first particles. The obstructions are formed or disposed in the analysis area and configured to capture the first particles in the analysis area and to allow the second particles and unreacted fluid to pass out of the analysis area. Additionally or alternatively, the lab-on-chip platform provides for a microfluidic chip that can be used to quantify key mineralization aspects, for instance, carbonate volume generated, mineralization rate, rock dissolution rate, crystal formation time, etc.

In embodiments, the microfluidic path includes the multiple inputs upstream from the mixing area by which multiple fluids and/or chemicals are flown into the microfluidic path for mixing in the mixing area and the output downstream from the analysis area which is receptive of the second particles and the unreacted fluid passing out of the analysis area and the multiple fluids and/or chemicals include at least one or more of water, brine, oil, carbon dioxide and a reagent. Additionally or alternatively, the multiple inputs and the output provide for fluid flow through the lab-on-chip platform whereby the fluid can be reactive with the mineral layer.

In embodiments, the mineral layer includes one or more of carbonates and silicates. Additionally or alternatively, the mineral layer is formed to mimic a rock sample.

In embodiments, the obstructions include at least one of bottleneck forming channels arranged along a longitudinal axis of the analysis area for capturing the first particles and blocks forming a sieve spanning a width of the analysis area for capturing the first particles. Additionally or alternatively, the obstructions are configured to capture the first particles for analysis.

In embodiments, an apparatus for mineralization rate measurement includes a data acquisition system (DAS) and the lab-on-chip platform, the analysis area being exposed to the DAS via the cover and the DAS being configured to analyze a presence of the first particles captured in the analysis area for determining a mineralization rate. Additionally or alternatively, the apparatus provides for mineralization rate measurement of a type of a rock sample.

In embodiments, the DAS includes at least one of a microscope and a spectroscope. Additionally or alternatively, the DAS is capable of various types of data acquisition and analysis.

In embodiments, the microfluidic path includes the multiple inputs upstream from the mixing area by which multiple fluids and/or chemicals are flown into the microfluidic path for mixing in the mixing area and the output downstream from the analysis area which is receptive of the second particles and the unreacted fluid passing out of the analysis area and the multiple fluids and/or chemicals include at least one or more of water, brine, oil, carbon dioxide and a reagent. Additionally or alternatively, the multiple inputs and the output provide for fluid flow through the lab-on-chip platform whereby the fluid can be reactive with the mineral layer.

In embodiments, the mineral layer includes one or more of carbonates and silicates. Additionally or alternatively, the mineral layer is formed to mimic a rock sample.

In embodiments, the obstructions include at least one of bottleneck forming channels arranged along a longitudinal axis of the analysis area for capturing the first particles and blocks forming a sieve spanning a width of the analysis area for capturing the first particles. Additionally or alternatively, the obstructions are configured to capture the first particles for analysis.

According to an aspect of the invention, a method of mineralization rate measurement is provided. A non-limiting example of the method includes forming a lab-on-chip platform with a microfluidic path having multiple inputs and an output and an analysis area downstream from a mixing area, depositing a mineral layer in at least the mixing area, forming or disposing obstructions in the analysis area and disposing a cover on a substrate to partially enclose the microfluidic path. The method further includes flowing a fluid along the microfluidic path such that, in the mixing area, the fluid forms first particles and second particles, which are substantially smaller than the first particles, through chemical interactions with the mineral layer or remains unreacted, and, in the analysis area, the obstructions capture the first particles and allow the second particles and unreacted fluid to pass out of the analysis area. In addition, the method includes analyzing a presence of the first particles captured in the analysis area to determine a mineralization rate. Additionally or alternatively, the method provides for quantification of key mineralization aspects, for instance, carbonate volume generated, mineralization rate, rock dissolution rate, crystal formation time, etc.

In embodiments, the analyzing includes at least one of microscopy and spectroscopy via the cover. Additionally or alternatively, the cover allows for executions of microscopy or spectroscopy via the cover.

In embodiments, the forming of the lab-on-chip platform includes etching the microfluidic path such that the microfluidic path includes the multiple inputs upstream from the mixing area by which the fluid is flown into the microfluidic path for mixing in the mixing area and the output downstream from the analysis area and receptive of the second particles and the unreacted fluid passing out of the analysis area and the fluid includes multiple fluids and/or chemicals including at least one or more of water, brine, oil, carbon dioxide and a reagent. Additionally or alternatively, the multiple inputs and the output provide for fluid flow through the lab-on-chip platform whereby the fluid can be reactive with the mineral layer.

In embodiments, the mineral layer includes one or more of carbonates and silicates. Additionally or alternatively, the mineral layer is formed to mimic a rock sample.

In embodiments, the depositing of the mineral layer includes at least one of chemical vapor deposition (CVD) and laser pulsed deposition (LPD). Additionally or alternatively, the deposition of the mineral layer using CVD or LPD allows for variations in a topography of the mineral layer to better mimic characteristics of a rock sample.

In embodiments, the depositing of the mineral layer includes changing depositional parameters along the microfluidic path to provide varying surface topologies that mimic rock porosity. Additionally or alternatively, the changing of the depositional parameters to provide for the varying surface topologies that mimic rock porosity can provide for greater flexibility in a study of mineralization rates.

In embodiments, the disposing of the obstructions in the analysis area includes at least one of arranging bottleneck forming channels along a longitudinal axis of the analysis area such that the first particles are capturable in the bottleneck forming channels for the analyzing and disposing blocks forming a sieve spanning a width of the analysis area such that the first particles are capturable in the sieve for the analyzing. Additionally or alternatively, the obstructions are configured to capture the first particles for analysis.

According to an aspect of the invention, a lab-on-chip platform is provided. A non-limiting example of the lab-on-chip platform includes a substrate in which a microfluidic path is formed having multiple inputs and an output and an analysis area, a cover placed on the substrate to partially enclose the microfluidic path and a mineral layer disposed in the microfluidic path and including a central mineral layer sandwiched between non-mineral layers. The central mineral layer is exposed to and etched by fluid flowing along the microfluidic path such that a capacitance of the mineral layer changes over time. Additionally or alternatively, the lab-on-chip platform provides for a microfluidic chip that can be used to quantify key mineralization aspects, for instance, carbonate volume generated, mineralization rate, rock dissolution rate, crystal formation time, etc.

In embodiments, at least one of the central mineral layer includes one or more of carbonates and silicates and the non-mineral layers include metallic materials and the central mineral layer has at least first and second sections and includes one or more of first carbonates and silicates and one or more of second carbonates and silicates in the first and second sections, respectively, and the non-mineral layers include metallic materials. Additionally or alternatively, the mineral layer is formed to mimic a rock sample and/or a rock sample with variable characteristics.

In embodiments, an apparatus for mineralization rate measurement includes a data acquisition system (DAS) and the lab-on-chip platform, the DAS being configured to determine a change of the capacitance of the mineral layer over time for determining a mineralization rate. Additionally or alternatively, the apparatus provides for mineralization rate measurement of a type of a rock sample.

In embodiments, at least one of the central mineral layer includes one or more of carbonates and silicates and the non-mineral layers include metallic materials and the central mineral layer has at least first and second sections and includes one or more of first carbonates and silicates and one or more of second carbonates and silicates in the first and second sections, respectively, and the non-mineral layers include metallic materials. Additionally or alternatively, the mineral layer is formed to mimic a rock sample and/or a rock sample with variable characteristics

For the sake of brevity, conventional techniques related to semiconductor device and integrated circuit (IC) fabrication may or may not be described in detail herein. Moreover, the various tasks and process steps described herein can be incorporated into a more comprehensive procedure or process having additional steps or functionality not described in detail herein. In particular, various steps in the manufacture of semiconductor devices and semiconductor-based ICs are well known and so, in the interest of brevity, many conventional steps will only be mentioned briefly herein or will be omitted entirely without providing the well-known process details.

Turning now to an overview of technologies that are more specifically relevant to aspects of the invention, human activities annually generate about 50 billion tons of carbon dioxide and it has been proposed that storage of carbon dioxide in underground geological formations may be a promising route to reduce atmospheric carbon dioxide concentrations to thereby limit or mitigate climate change.

Geological CO₂ storage is considered the most stable form of CO₂ storage and involves the injection of carbon laden solutions directly into the pore space of subsurface rock formations, such as saline aquifers and abandoned oil reservoirs. These techniques are being developed for implementation in different reservoirs at distinct pressures and temperatures and with differing chemical and physical compositions. Thus, it is apparent that key aspects for successful executions of geological sequestration of carbon dioxide include understanding pore structure and chemical properties of reservoirs as well as understanding how aspects of CO₂ injection into rock reservoirs affect mineralization.

Presently, the study of fluid flow on rock formations typically involves core flooding tests, which can determine rock porosity and permeability. In this type of test, a cylinder rock sample is removed from a reservoir and placed in a holder with known dimensions. The outer surface of the rock sample is pressurized to simulate the pressure of the reservoir. A test fluid is then pumped through the rock sample and flow rates and pressure drop across the rock sample are measured. From this data, the resistance to flow of the rock sample is evaluated.

A drawback of core flooding tests is that they cannot be used to evaluate chemical interactions between the injection fluid and the rock surface. To study geological CO₂ mineralization reactions, a method is needed where mineralization rates can be determined as a function of the mineral composition of the rock reservoir, the chemical composition of the injection fluids and the physical conditions of the reservoir (i.e., temperature and pressure). It is particularly difficult to acquire deep understand of the chemical reactions between the injection fluids and the minerals at rock reservoir in real time.

Turning now to an overview of the aspects of the invention, one or more embodiments of the invention address the above-described shortcomings of the prior art by providing a lab-on-chip platform that has channel surfaces covered by minerals which allow for the study of flow and carbon dioxide mineralization in porous media models on well-defined microscale geometries. With this combination of features, optical imaging and spectroscopy techniques can be used to monitor the flow of carbon dioxide laden fluids in constricted geometries during single-phase and multi-phase flow experiments on the microfluidic chip, to monitor fluid dynamics in real time and to execute particle tracking to extract physical properties of the fluid, such as its flow speed. This allows for validation of fluid flow models and provides insights into the percolation of fluid in real rock samples. In parallel, this also allows for the study of the reaction kinetics between the carbon laden solutions and the mineral surface within the porous channels of the microfluidic chip as well as the measurement of mineral precipitation and dissolution rates in real-time by employing optical microscopy and spectroscopy. The study of these reactions is necessary for revealing the mechanisms that govern dissolution and precipitation reactions which are key for modelling mineral trapping. In addition, this method can be applied for verification and measurement of volumes of accumulations at microscopic scales and for estimating mineralization rates that feed into the chemical reaction models to be applied in larger porous geometries. The outcome of such measurements can allow for the building and calibration of computational models that consider joint effects of infiltration, dissolution and mineralization of carbon dioxide at the pore scale.

The above-described aspects of the invention address the shortcomings of the prior art by providing for a lab-on-chip platform. The lab-on-chip platform includes a substrate. The substrate includes a microfluidic path. The microfluidic path has multiple inputs and an output and an analysis area downstream from a mixing area. The lab-on-chip platform further includes a cover disposed on the substrate to partially enclose the microfluidic path, a mineral layer deposited in at least the mixing area and obstructions. The mineral layer is configured to at least partially chemically react with fluid within the microfluidic path to form at least first particles and second particles, which are substantially smaller than the first particles. The obstructions are formed or disposed in the analysis area and configured to capture the first particles in the analysis area and to allow the second particles and unreacted fluid to pass out of the analysis area. In addition, this apparatus for mineralization rate measurement includes a DAS which is configured to analyze the presence of the first particles captured in the analysis area for determining a mineralization rate. The analysis area of the lab-on-chip platform is exposed to the DAS via the cover.

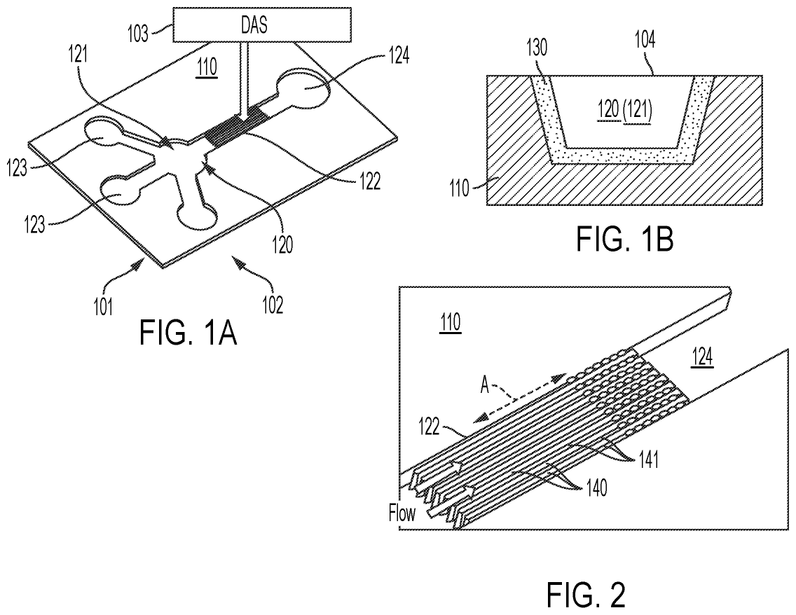

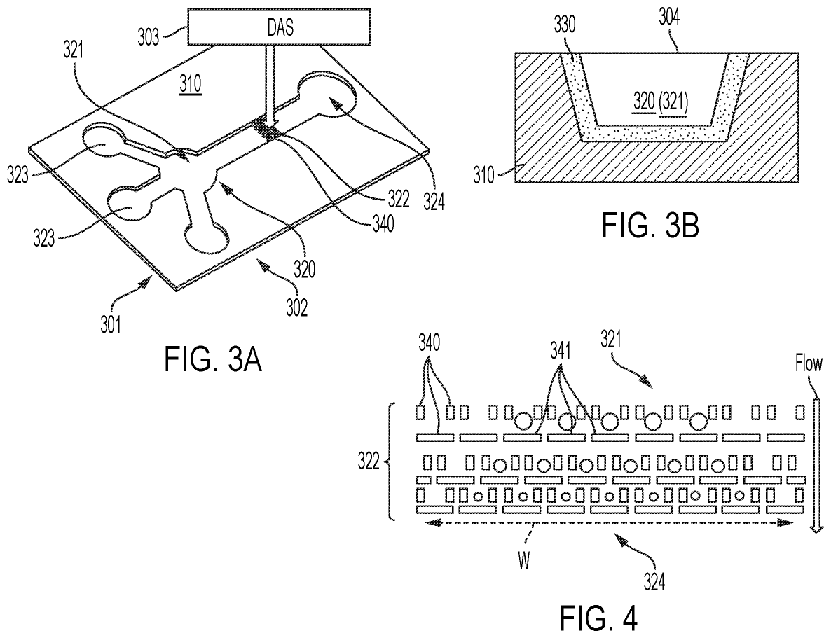

Turning now to a more detailed description of aspects of the present invention, FIGS. 1A and 1B and FIG. 2 and FIGS. 3A and 3B and FIG. 4 depict perspective and cross section views of an apparatus for mineralization rate measurement including a lab-on-chip platform with bottlenecks in an analysis area (see FIGS. 1A and 1B and FIG. 2) or a sieve in an analysis area (see FIGS. 3A and 3B and FIG. 4) and a data acquisition system (DAS) in accordance with one or more embodiments of the present invention;

As shown in FIGS. 1A and 1B and FIG. 2, a lab-on-chip platform 101 includes a substrate 110 that can be formed of silicon or another suitable material in which a microfluidic path 120 is formed by etching or another suitable process. The microfluidic path 120 has a mixing area 121, an analysis area 122 defined downstream from the mixing area 121, one or more inputs 123 defined upstream from the mixing area 121 and by which multiple fluids and/or chemicals are flown into the microfluidic path 120 for mixing in the mixing area 121 and an output 124 defined downstream from the analysis area 122. The lab-on-chip platform 101 further includes a mineral layer 130 (see FIG. 1B) deposited in at least the mixing area 121 and obstructions 140 formed or disposed in the analysis area 122. Fluid flowing along the microfluidic path 120 from the one or more inputs 123, through the mixing area 121, through the analysis area 122 and to the output 124 forms first particles and second particles, which are substantially smaller than the first particles, through chemical interactions with the mineral layer 130 in at least the mixing area 121 or remains unreacted. The obstructions 140 are configured to capture the first particles in the analysis area 122 (see FIG. 2) and to allow the second particles that are sufficiently small and unreacted fluid to pass out of the analysis area 122 to the output 124. The output 124 is thus receptive of the second particles and the unreacted fluid passing out of the analysis area 122.

In accordance with embodiments, the obstructions 140 can include bottleneck forming channels 141 that are arranged along a longitudinal axis A of the analysis area 122 for capturing the first particles. The multiple fluids and/or chemicals of the fluid can include at least one or more of water, brine, oil, carbon dioxide and/or a reagent and the mineral layer 130 can include but not limited to carbonates, such as calcium carbonate, and silicates, such as calcium silicates. During an operation of the lab-on-chip platform 101, as the fluid moves through the microfluidic path 120, the fluid chemically interacts with the mineral layer 130 at a certain mineralization rate to form the first and second particles or to otherwise remain unreacted. This mineralization rate can be dependent on various factors including, but not limited to, the pressure of the fluid, the flow rate of the fluid, the geometry and topography of the mineral layer 130, etc., all of which are known and controllable to mimic a type of a rock sample that is being studied. The amount of the first particles that are captured by the bottleneck forming channels 141 can be measured by microscopy or spectroscopy techniques and this result can be used to determine a mineralization rate of the type of the rock sample, according to the fluid applied in the microfluidic chip, operation condition of experiments (pressure, temperature) and chemical proprieties of the sample fluids (chemical composition and concentration).

As shown in FIG. 1A, the lab-on-chip platform 101 can be provided as a component of an apparatus 102 for mineralization rate measurement. The apparatus 102 can include a DAS 103, the lab-on-chip platform 101 and an optically transparent cover 104 (see FIG. 1B). The DAS 103 can include or be provided as a microscope for microscopy and/or as a spectroscope for spectroscopy. The transparent cover 104 is put on top of the substrate 110 to enclose the microfluidic path 120. The analysis area 122 is exposed to the DAS 103 via the transparent cover 104. The DAS 103 is configured to analyze (i.e., by microscopy, spectroscopy, or another suitable process) a presence of the first particles captured by the bottleneck forming channels 141 in the analysis area 122 for the determining of the mineralization rate of the type of the rock sample.

As shown in FIGS. 3A and 3B and FIG. 4, a lab-on-chip platform 301 includes a substrate 310 that can be formed of silicon or another suitable material in which a microfluidic path 320 is formed by etching or another suitable process. The microfluidic path 320 is enclosed by an optically transparent cover 304, has a mixing area 321, an analysis area 322 defined downstream from the mixing area 321, one or more inputs 323 defined upstream from the mixing area 321 and by which multiple fluids and/or chemicals are flown into the microfluidic path 320 for mixing in the mixing area 321 and an output 324 defined downstream from the analysis area 322. The lab-on-chip platform 301 further includes a mineral layer 330 (see FIG. 3B) deposited in at least the mixing area 321 and obstructions 340 formed or disposed in the analysis area 322. Fluid flowing along the microfluidic path 320 from the one or more inputs 323, through the mixing area 321, through the analysis area 322 and to the output 324 forms first particles and second particles, which are substantially smaller than the first particles, through chemical interactions with the mineral layer 330 in at least the mixing area 321 or remains unreacted. The obstructions 340 are configured to capture the first particles in the analysis area 322 (see FIG. 4) and to allow the second particles that are sufficiently small and unreacted fluid to pass out of the analysis area 322 to the output 324. The output 324 is thus receptive of the second particles and the unreacted fluid passing out of the analysis area 322.

In accordance with embodiments, the obstructions 340 can include blocks forming a sieve 341 spanning a width W of the analysis area 322 for capturing the first particles. The multiple fluids and/or chemicals of the fluid can include at least one or more of water, brine, oil, carbon dioxide and/or a reagent and the mineral layer 330 can include, but not limited to, carbonates, such as calcium carbonate, and silicates, such as calcium silicates. During an operation of the lab-on-chip platform 301, as the fluid flows through the microfluidic path 320, the fluid chemically interacts with the mineral layer 330 at a certain mineralization rate to form the first and second particles or to otherwise remain unreacted. This mineralization rate can be dependent on various factors including, but not limited to, the pressure of the fluid, the flow rate of the fluid, the geometry and topography of the mineral layer 330, etc., all of which are known and controllable to mimic a type of a rock sample that is being studied. The amount of the first particles that are captured by sieve 341 can be measured and this measured amount can be used to determine a mineralization rate of the type of the rock sample.

As shown in FIG. 3A, the lab-on-chip platform 301 can be provided as a component of an apparatus 302 for mineralization rate measurement. The apparatus 302 can include a DAS 303, the lab-on-chip platform 301 and an optically transparent cover 304 (see FIG. 3B). The DAS 303 can include or be provided as a microscope for microscopy and/or as a spectroscope for spectroscopy. The transparent cover 304 is positioned on the substrate 310 to enclose the microfluidic path 320. The analysis area 322 is exposed to the DAS 303 via the transparent cover 304. The DAS 303 is configured to analyze (i.e., by microscopy, spectroscopy, or another suitable process) a presence of the first particles captured by the bottleneck forming channels 141 in the analysis area 322 for the determining of the mineralization rate of the type of the rock sample, according to the fluid applied in the microfluidic chip, operation condition of experiments (pressure, temperature) and chemical proprieties of the sample fluids (chemical composition and concentration).

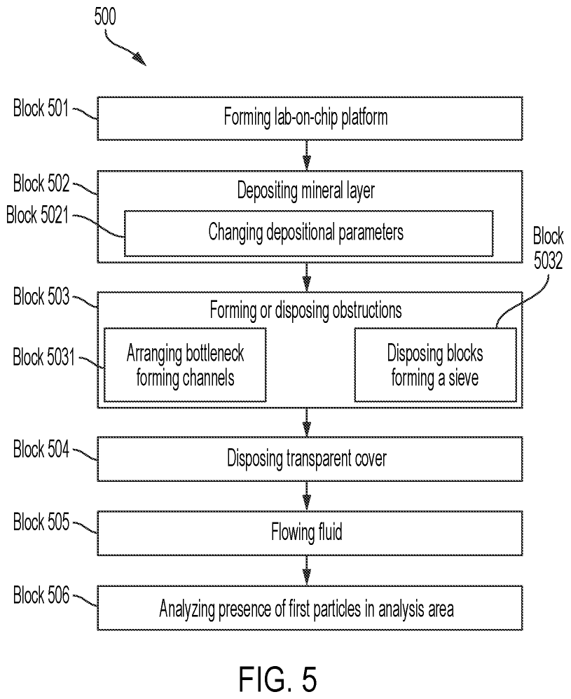

With reference to FIG. 5, a method 500 of mineralization rate measurement is provided. As shown in FIG. 5, the method 500 includes forming a lab-on-chip platform with a microfluidic path having an analysis area downstream from a mixing area, one or more inputs upstream from the mixing area by which fluid (e.g., multiple fluids and/or chemicals including at least one or more of water, brine, oil, carbon dioxide and/or a reagent) can be flown into the microfluidic path for mixing in the mixing area and an output downstream from the analysis area as described above by etching or another suitable process (block 501). In addition, method 500 includes depositing a mineral layer in at least the mixing area by chemical vapor deposition (CVD), laser pulsed deposition (LPD) or another suitable depositional process (block 502). In some cases, the deposition of the mineral layer of block 502 can include changing depositional parameters along the microfluidic path to provide varying surface topologies that mimic rock porosity (block 5021).

The method 500 also includes forming or disposing obstructions in the analysis area (block 503). As described above, the forming or disposing of the obstructions in the analysis area of block 503 can include arranging bottleneck forming channels along a longitudinal axis of the analysis area such that the first particles are capturable in the bottleneck forming channels for the analyzing (block 5031) and/or disposing blocks forming a sieve spanning a width of the analysis area such that the first particles are capturable in the sieve for the analyzing (block 5032).

The method 500 further includes disposing a transparent cover on the substrate to enclose the microfluidic path (block 504) and flowing a fluid along the microfluidic path such that, in the mixing area, the fluid forms first particles and second particles, which are substantially smaller than the first particles, through chemical interactions with the mineral layer or remains unreacted, and, in the analysis area, the obstructions capture the first particles and allow the second particles and unreacted fluid to pass out of the analysis area (block 505). In addition, method 500 can include analyzing a presence of the first particles captured in the analysis area to determine a mineralization rate by at least one of microscopy and spectroscopy executed via the transparent cover (block 506).

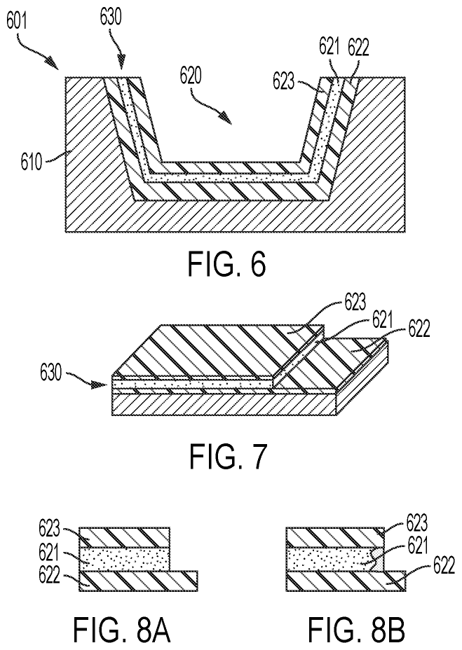

With reference to FIGS. 6-9, a lab-on-chip platform 601 is provided and is generally similar to the lab-on-chip platforms 101 and 301 of FIGS. 1A and 3A. The lab-on-chip platform 601 includes a substrate 610 in which a microfluidic path 620 is formed as described above, a mineral layer 630 and an optically transparent cover (see FIGS. 1B and 3B). The mineral layer 630 is disposed in the microfluidic path 620 and includes a central mineral layer 621 that is sandwiched between non-mineral layers 622, 623. The central mineral layer 621 can be exposed to and etched by fluid flowing along the microfluidic path 620 owing to, for example, the difference in length between the non-mineral layer 622 and the central mineral layer 621 and the non-mineral layer 623. The etching of the central mineral layer 621 is illustrated in FIGS. 8A and 8B and leads to a change in the capacitance of the mineral layer 621 over time.

In accordance with one or more embodiments of the present invention, the central mineral layer 621 can include one or more carbonates and silicates and the non-mineral layers 622, 623 can include metallic materials (see FIG. 7). As an alternative, in accordance with one or more embodiments of the present invention, the central mineral layer 621 can have at least first and second sections 6211, 6212 and can include one or more of first carbonates and silicates and one or more of second carbonates and silicates in the first and second sections 6211, 6212, respectively, and the non-mineral layers 622, 623 can include metallic materials.

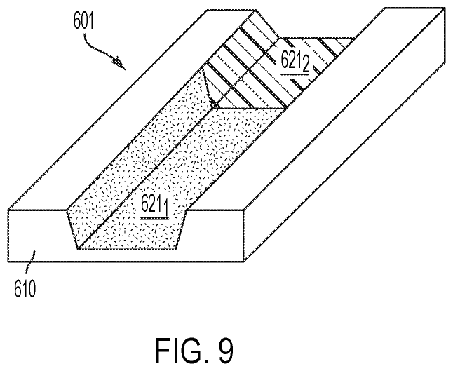

In accordance with one or more embodiments of the present invention, the mineral layer 630 can include one or more of carbonates and silicates. As an alternative, in accordance with one or more embodiments of the present invention, the mineral layer 630 can have at least first and second sections as shown in FIG. 9 and can include one or more of first carbonates and silicates and one or more of second carbonates and silicates in the first and second sections, respectively.

The lab-on-chip platform 601 can be provided as a component in an apparatus for mineralization rate measurement generally as described above with reference to FIGS. 1A and 3A. The apparatus would include a DAS, with the DAS being configured generally as described above to determine a change of the capacitance of the mineral layer 621 over time for determining a mineralization rate of a type of a rock sample being studied.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The term “conformal” (e.g., a conformal layer) means that the thickness of the layer is substantially the same on all surfaces, or that the thickness variation is less than 15% of the nominal thickness of the layer.

The terms “epitaxial growth and/or deposition” and “epitaxially formed and/or grown” mean the growth of a semiconductor material (crystalline material) on a deposition surface of another semiconductor material (crystalline material), in which the semiconductor material being grown (crystalline overlayer) has substantially the same crystalline characteristics as the semiconductor material of the deposition surface (seed material). In an epitaxial deposition process, the chemical reactants provided by the source gases can be controlled and the system parameters can be set so that the depositing atoms arrive at the deposition surface of the semiconductor substrate with sufficient energy to move about on the surface such that the depositing atoms orient themselves to the crystal arrangement of the atoms of the deposition surface. An epitaxially grown semiconductor material can have substantially the same crystalline characteristics as the deposition surface on which the epitaxially grown material is formed. For example, an epitaxially grown semiconductor material deposited on a {100} orientated crystalline surface can take on a {100} orientation. In some embodiments of the invention, epitaxial growth and/or deposition processes can be selective to forming on semiconductor surface, and cannot deposit material on exposed surfaces, such as silicon dioxide or silicon nitride surfaces.

As previously noted herein, for the sake of brevity, conventional techniques related to semiconductor device and integrated circuit (IC) fabrication may or may not be described in detail herein. By way of background, however, a more general description of the semiconductor device fabrication processes that can be utilized in implementing one or more embodiments of the present invention will now be provided. Although specific fabrication operations used in implementing one or more embodiments of the present invention can be individually known, the described combination of operations and/or resulting structures of the present invention are unique. Thus, the unique combination of the operations described in connection with the fabrication of a semiconductor device according to the present invention utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), and chemical-mechanical planarization (CMP), and the like. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A lab-on-chip platform, comprising:
a substrate comprising a microfluidic path, the microfluidic path having multiple inputs and an output and an analysis area downstream from a mixing area;
a cover disposed on the substrate to partially enclose the microfluidic path;
a mineral layer deposited in at least the mixing area, the mineral layer configured to at least partially chemically react with fluid within the microfluidic path to form at least first particles and second particles, which are substantially smaller than the first particles; and
obstructions formed or disposed in the analysis area and configured to capture the first particles in the analysis area and to allow the second particles and unreacted fluid to pass out of the analysis area.

2. The lab-on-chip platform according to claim 1, wherein:
the multiple inputs are upstream from the mixing area by which multiple fluids and/or chemicals are flown into the microfluidic path for mixing in the mixing area; and
the output is downstream from the analysis area and is receptive of the second particles and the unreacted fluid passing out of the analysis area,
the multiple fluids and/or chemicals comprise at least one or more of water, brine, oil, carbon dioxide and a reagent.

3. The lab-on-chip platform according to claim 1, wherein the mineral layer comprises one or more of carbonates and silicates.

4. The lab-on-chip platform according to claim 1, wherein the obstructions comprise at least one of:
bottleneck forming channels arranged along a longitudinal axis of the analysis area for capturing the first particles; and
blocks forming a sieve spanning a width of the analysis area for capturing the first particles.

5. An apparatus for mineralization rate measurement, comprising:
a data acquisition system (DAS); and
the lab-on-chip platform according to claim 1,
wherein the analysis area is exposed to the DAS via the cover and the DAS is configured to analyze a presence of the first particles captured in the analysis area for determining a mineralization rate.

6. The apparatus according to claim 5, wherein the DAS comprises at least one of a microscope and a spectroscope.

7. The apparatus according to claim 5, wherein the microfluidic path comprises:
the multiple inputs are upstream from the mixing area by which multiple fluids and/or chemicals are flown into the microfluidic path for mixing in the mixing area; and
the output is downstream from the analysis area and is receptive of the second particles and the unreacted fluid passing out of the analysis area, and
the multiple fluids and/or chemicals comprise at least one or more of water, brine, oil, carbon dioxide and a reagent.

8. The apparatus according to claim 5, wherein the mineral layer comprises one or more of carbonates and silicates.

9. The apparatus according to claim 5, wherein at least one of:
the obstructions comprise bottleneck forming channels arranged along a longitudinal axis of the analysis area and the first particles are capturable in the bottleneck forming channels for mineralization rate measurement by the DAS, and
the obstructions comprise blocks forming a sieve spanning a width of the analysis area and the first particles are capturable in the sieve for mineralization rate measurement by the DAS.

10. A method of mineralization rate measurement, comprising:
forming a lab-on-chip platform with a microfluidic path having multiple inputs and an output and an analysis area downstream from a mixing area;
depositing a mineral layer in at least the mixing area;
forming or disposing obstructions in the analysis area;
disposing a cover on a substrate to partially enclose the microfluidic path; and
flowing a fluid along the microfluidic path such that:
in the mixing area, the fluid forms first particles and second particles, which are substantially smaller than the first particles, through chemical interactions with the mineral layer or remains unreacted, and,
in the analysis area, the obstructions capture the first particles and allow the second particles and unreacted fluid to pass out of the analysis area; and
analyzing a presence of the first particles captured in the analysis area to determine a mineralization rate.

11. The method according to claim 10, wherein the analyzing comprises at least one of microscopy and spectroscopy via the cover.

12. The method according to claim 10, wherein the forming of the lab-on-chip platform comprises etching the microfluidic path such that the microfluidic path comprises:
the multiple inputs upstream from the mixing area by which the fluid is flown into the microfluidic path for mixing in the mixing area; and
the output downstream from the analysis area and receptive of the second particles and the unreacted fluid passing out of the analysis area, and
wherein the fluid comprises multiple fluids and/or chemicals comprising at least one or more of water, brine, oil, carbon dioxide and a reagent.

13. The method according to claim 10, wherein the mineral layer comprises one or more of carbonates and silicates.

14. The method according to claim 10, wherein the depositing of the mineral layer comprises at least one of chemical vapor deposition (CVD) and laser pulsed deposition (LPD).

15. The method according to claim 10, wherein the depositing of the mineral layer comprises changing depositional parameters along the microfluidic path to provide varying surface topologies that mimic rock porosity.

16. The method according to claim 10, wherein the disposing of the obstructions in the analysis area comprises at least one of:
arranging bottleneck forming channels along a longitudinal axis of the analysis area such that the first particles are capturable in the bottleneck forming channels for the analyzing, and
disposing blocks forming a sieve spanning a width of the analysis area such that the first particles are capturable in the sieve for the analyzing.

17. A lab-on-chip platform, comprising:
a substrate in which a microfluidic path is formed having multiple inputs and an output and an analysis area;
a cover placed on the substrate to partially enclose the microfluidic path; and
a mineral layer disposed in the microfluidic path and comprising a central mineral layer sandwiched between non-mineral layers,
the central mineral layer being exposed to and etched by fluid flowing along the microfluidic path such that a capacitance of the mineral layer changes over time.

18. The lab-on-chip platform according to claim 17, wherein at least one of:
the central mineral layer comprises one or more of carbonates and silicates and the non-mineral layers comprise metallic materials, and
the central mineral layer has at least first and second sections and comprises one or more of first carbonates and silicates and one or more of second carbonates and silicates in the first and second sections, respectively, and the non-mineral layers comprise metallic materials.

19. An apparatus for mineralization rate measurement, comprising:
a data acquisition system (DAS); and
the lab-on-chip platform according to claim 17,
wherein the DAS is configured to determine a change of the capacitance of the mineral layer over time for determining a mineralization rate.

20. The apparatus according to claim 19, wherein at least one of:
the central mineral layer comprises one or more of carbonates and silicates and the non-mineral layers comprise metallic materials, and
the central mineral layer has at least first and second sections and comprises one or more of first carbonates and silicates and one or more of second carbonates and silicates in the first and second sections, respectively, and the non-mineral layers comprise metallic materials.
